(19) United States
(12) Patent Application Publication
(10) Pub. No.: US 2014/0374364 A1
(43) Pub. Date: Dec. 25, 2014

(54) METHOD FOR THE SEDIMENTATION OF SEDIMENT PARTICLES IN A METHOD FOR EXTRACTING DIESEL

(71) Applicant: ECOTECFUEL, LLC, RENO, NV (US)

(72) Inventor: Wolfgang Spiess, Rosstal (DE)

(73) Assignee: ECOTOECFUEL, LLC, RENO, NV (US)

(21) Appl. No.: 14/373,233

(22) PCT Filed: Jan. 18, 2013
(86) PCT No.: PCT/EP2013/050983

§ 371 Date: Jul. 18, 2014

(30) Foreign Application Priority Data
Jan. 20, 2012 (DE) 102012000975.5

(51) Int. Cl. B01D 21/00; C10G 53/08; B01D 21/26

(52) U.S. Cl. CPC B01D 21/0087; B01D 21/265; C10G 53/08
USPC 210/801; 210/532.1

(57) ABSTRACT

The invention relates to a method and a device for the sedimentation of sediment particles in a method for extracting diesel oil from a liquid substance mixture moving in a circuit and comprising oil, hydrocarbon-containing residues and catalyst particles, by means of catalytic, pressureless depolymerisation (CPD). Sediment particles are removed from the substance mixture by guiding said mixture via a spiral-shaped guide arrangement. Hydrocarbon-containing residues are admitted into a lattice arrangement downstream of the spiral-shaped guide arrangement, wherein the substance mixture flows around or flows through said lattice arrangement.

The invention concerns a method for the sedimentation of sedimentary particles in a process for the recovery of diesel oil from a fluid substance mixture circulating in a circuit and comprising oil, hydrocarbon-containing residues and catalyst particles by means of catalytic pressure-free depolymerization (KDV), as well as a sedimentor to carry out the method.

From DE 10 2005 056 735 B3 is known the method for producing diesel o from hydrocarbon-containing waste materials in a substance mixture circuit with solids separation and product distillation for the diesel product. The substance mixture is an oil, residues and catalyst mixture. The residues used contain long-chain hydrocarbons which are split by means of the catalyst into short-chain hydrocarbons that are suitable as a diesel component. A separator is provided for the evaporation of the diesel component from the fluid substance mixture heated to 280 to 320° C. and circulating in a circuit; the substance mixture is sprayed into the separator by means of the venturi to produce a large evaporation surface.

During extended operation, the catalyst substance used may become inactive because components separated from the substance mixture is deposited on the catalyst surface. Thus, the diesel oil yield decreases.

The object of the present invention is to provide an improved method and device for carrying out the improved method.

According to the invention, this object is achieved by means of the subject matter of claim 1. A method is proposed for the sedimentation of sediment particles in a process for the recovery of diesel oil from a fluid substance mixture circulating in a circuit and comprising oil, hydrocarbon residues and catalyst particles by means of catalytic pressure-free depolymerization (KDV), whereby sediment particles are removed from the substance mixture by passing it through a spiral-shaped guide, and the hydrocaron-containing residues are input downstream of the spiral-shaped guide in a grid device which the substance mixture flows round and/or through.

Interference-free operation is possible by sedimentation of the substance mixture, whereby the sediment may be treated in further process steps after sampling, for example for the separation of contaminants and recyclable waste substances.

It may be arranged that the substance mixture, after emerging from the guide, is so deflected that it flows around the grid device from top to bottom.

In an advantageous embodiment, it may be arranged that the sediment particles comprise inactivated catalyst particles.

It may further be arranged that the substance mixture is swirled in a labyrinth-like device arranged between the spiral guide and the grid device. The separation of the sediments may be achieved through the swirling as a function of their mass distribution, whereby high-mass sediment particles flow outwards in the vortex, while low-mass sediment particles flow inwards.

Further claims concern the sedimentor used in the process.

It may be arranged that the sedimentor comprises a central container, whereby an outer inside liner, an inner inside liner and a grid liner are arranged nested within one another in the central container, and whereby between the central container, the outer inside liner, the inner inside liner and the grid liner, respectively, a space is formed, whereby the said spaces form a labyrinth-like flow-through space for the substance mixture, and whereby a spiral-shaped guide is arranged in the space between the central container and the outer inside liner.

It may be advantageously arranged that the longitudinal axis of the central container is vertically oriented.

The central container, the outer inside liner, the inner inside liner and the grid liner may be arranged coaxially with one another.

It may be arranged that the spiral-shaped guide is arranged on the inner wall of the central container and/or on the outer wall of the outer inside liner.

It may further be arranged that the labyrinth-like through-flow space is formed by a plurality of flow spaces arranged coaxially to one another and each having an annular cross-section.

The substance mixture flowing through the flow-through spaces may be deflected by 180°. Preferably, the flow-through spaces may deflect the substance mixture alternately downwards and upwards.

The invention will now be explained in more detail with reference to embodiments. The Figures show

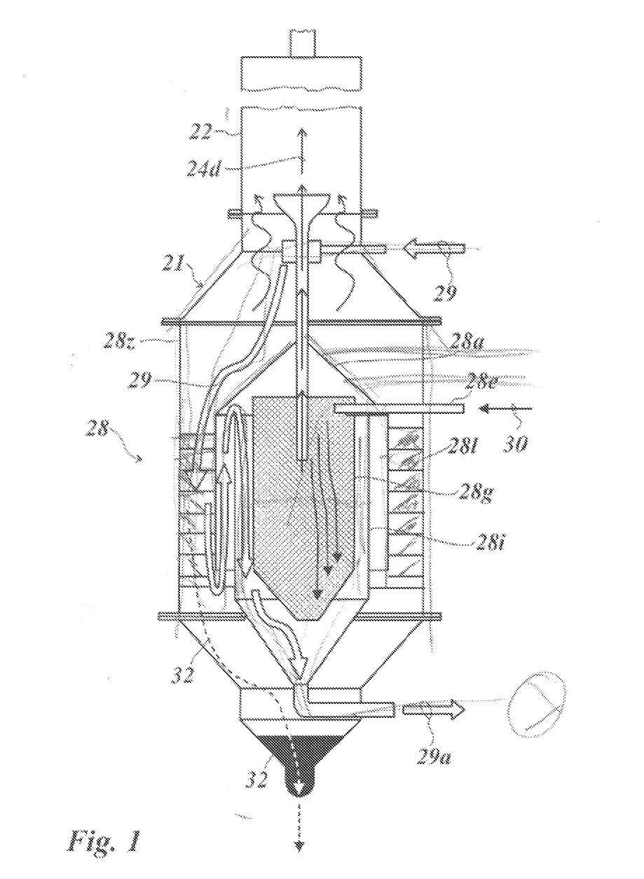

FIG. 1 shows a schematic cross-sectional view of an embodiment of a sedimentor used in the process according to the invention;

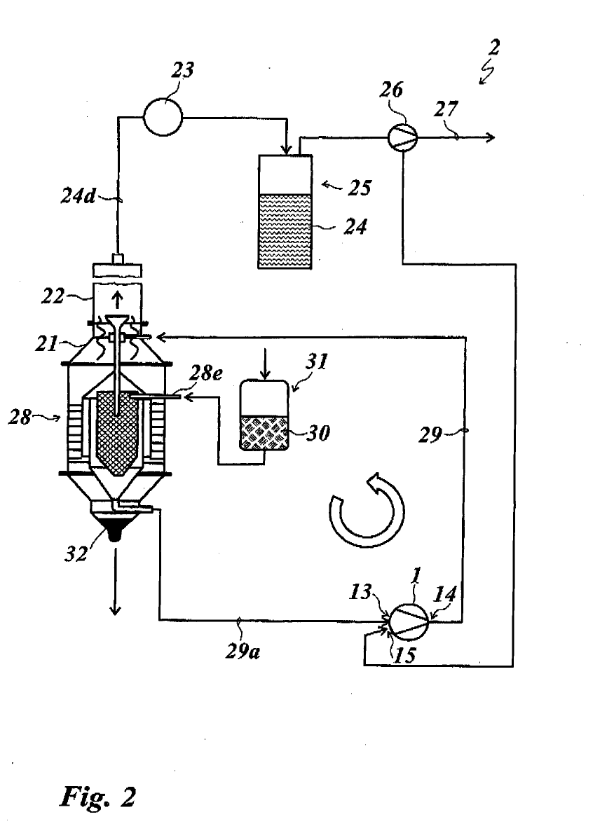

FIG. 2 shows a block diagram of an application example of the device in FIG. 1.

FIG. 1 shows an embodiment of a sedimentor that is used in KDV plant 2 presented in FIG. 2 for catalytic pressure-free depolymerization. In the KDV plant 2, long-chain hydrocarbons are split under the influence of a catalyst into short-chain hydrocarbons, such as those contained in diesel oil, at a process temperature of 280 to 320 C. For this purpose, a fluid substance mixture comprising oil, residues and catalyst at the process temperature is conveyed through a fluid ring pump 1 in the circuit.

The sedimentor 28 comprises a vertical central container 28z, above which a separator 21 is arranged. The central container 28z is formed as a cylindrical container, which merges into a conical base section. A distillation column 22 is arranged above the separator 21 as presented below in FIG. 2.

An outer inside liner 28a, an inner inside liner 28g and a grid liner 28i are arranged nested inside one another in the cylindrical container. The cup-shaped inner liners 28a and 28i each have a conical bottom. The bottom of the outer inside liner 28a goes upwards, while the bottom of the inner inside liner 28i goes downwards.

A space is formed in each case between the central container 28z, the outer inside liner 28a, the inner inside liner 28i and the grid liner 28g.

Short-chain hydrocarbons exit as a vapour 24d from the substance mixture 29 entering the separator 21 to form diesel oil 24 after condensation as described below. The evaporated substance mixture 29r is now fed into the space between the central container 28z and the outer inside liner 28a in which is arranged a spiral-shaped guide 28l down which the substance mixture 29r slides in a spiral.

The substance mixture 29r is swirled in the spiral-shaped device 28l, whereby sediment particles 32 are separated, which, after leaving the spiral-shaped device 28l, sink down as bottom sludge and are collected in the conical base sction of the central container 28z, from which they can be removed. The sediment particles also include inactivated catalyst particles, whose surface is contaminated.

The substance mixture 29r, freed of the sediment particles 32, now enters the space between the outer inside liner 28a and the inner inside liner 28i and flows upwards. Then the substance mixture passes into the space 29r between the inner inside liner 28g and the grid liner 28i, and thus entrains hydrocarbon-containing residue 30 introduced into the grid liner 28g, The residue 30 is dissolved by the substance mixture 29r heated to 280 to 320° and/or homogenized. A substance mixture 29a enriched with the residue 30 is thus formed, and leaves the central container 28 through the conical bottom of the inner inside liner 28i and re-enters the substance mixture circuit.

FIG. 2 shows an embodiment for use of the device described in FIG. 1.

The fluid ring pump 1 has a suction nozzle 13, a pressure nozzle 14 and a gas nozzle 15 to introduce an inert gas to produce a foam phase in the substance mixture 29a in the fluid ring pump 1. The substance mixture 29a still reacts with the catalyst particles in the fluid ring pump 1 causing long-chain hydrocarbons to be split into short-chain hydrocarbons. It thus forms a substance mixture 29 containing short-chain hydrocarbons.

The substance mixture 29 is introduced through a pipe into the separator 21 in which the short-chain hydrocarbons are evaporated. The vapour 24d flows into the distillation column 22 arranged above the separator 21, and then enters the condenser 23 arranged downstream of the distillation column 22. Condensate in the form of diesel oil 24 from the condenser 23 is collected in a product tank 25. The product tank 25 is vented using a vacuum pump 26, whereby a portion of the exhaust gas 27 accumulated above the diesel oil 24 is fed to the gas nozzle 15 of the fluid ring pump 1. To begin the process, an inert gas such as nitrogen is supplied from a compressed gas container in place of the exhaust gas.

The evaporated substance mixture 29r flows out from the separator 21 into the sedimentor 28 in which, as described above in FIG. 1, the sediment particles are removed from the substance mixture 29r and to which new residue 30 is added.

The enriched substance mixture 29a is then supplied to the suction nozzle 13 of the fluid ring pump 1 to close the substance mixture circuit.

### REFERENCE NUMERAL LIST

1 liquid ring pump
2 KDV plant
13 suction nozzle
14 pressure nozzle
15 gas nozzle
21 separator
22 distillation column
23 condenser
24 diesel oil
24d diesel vapour
25 product tank
26 vacuum pump
27 exhaust gas
28 sedimentor
28a outer inside liner
28e inlet nozzle
28g grid liner
28l guide
28i inner inside liner
28z central container
29 substance mixture
29a enriched substance mixture
29r evaporated substance mixture
30 residues
31 residue-reservoir
32 sediment particles

1. A method for the sedimenting of sediment particles in a process for the recovery of diesel oil from a fluid substance mixture circulating in a circuit and comprising oil, hydrocarbon residues and catalyst particles by means of catalytic pressure-free depolymerization (KDV),
wherein
the sediment particles are removed from the substance mixture by passing it through a spiral-shaped guide, and
the hydrocarbon-containing residues are introduced downstream behind the spiral-shaped guide into a grid device, whereby the substance mixture flows around and/or through.

2. A method according to claim 1,
wherein
the substance mixture on exiting from the guide is so deflected that it flows around the grid device from top to bottom.

3. A method according to claim 1,
wherein
the sediment particles comprise inactivated catalyst particles.

4. A method according to claim 1,
wherein
the substance mixture is swirled in a labyrinth-shaped device arranged between the spiral-shaped guide and the grid device.

5. A sedimentor for implementing the method according to claim 1, comprising a central container
wherein
an outer inside liner, an inner inside liner and a grid liner are arranged nested inside one another in the central container,
a space is formed respectively between the central container, the outer inside liner, the inner inside liner and the grid liner, whereby the spaces form a labyrinth-like flow-through space for the substance mixture, and
a spiral guide is arranged in the space between the central container and the outer inside liner.

6. A device according to claim 5,
wherein
the central container the outer inside liner, the inner inside liner and the grid liner are arranged coaxially inside one another.

7. A device according to claim 5,
wherein
the spiral-shaped guide is arranged on the inner wall of the central container and/or on the outer wall of the outer inside liner.

8. A device according to claim 5,
wherein
the labyrinth-like flow-through space is formed by a plurality of flow spaces arranged coaxially to one another and having an annular cross-section.

9. A device according to claim 5,
wherein
the substance mixture flowing through the flow-through spaces is deflected by 180°.

10. A device according to claim 5,
wherein
the longitudinal axis of the central container is oriented vertically.
